(19) United States
(12) Patent Application Publication
(10) Pub. No.: US 2022/0055451 A1
(43) Pub. Date: Feb. 24, 2022

(54) COOLING SYSTEM

(71) Applicant: DENSO CORPORATION, Kariya-city (JP)

(72) Inventors: Kouta MAJIMA, Kariya-city (JP); Takashi Yasuda, Kariya-city (JP); Takuya Mitsuhashi, Kariya-city (JP)

(21) Appl. No.: 17/453,434

(22) Filed: Nov. 3, 2021

Related U.S. Application Data
(63) Continuation of application No. PCT/JP2020/017363, filed on Apr. 22, 2020.

(30) Foreign Application Priority Data
May 14, 2019 (JP) 2019-091111

(51) Int. Cl. B60H 1/32; B60K 11/04

(52) U.S. Cl. CPC B60H 1/32; B60H 2001/3291; B60K 11/04

(57) ABSTRACT

A cooling system includes multiple heat exchangers, a shutter, and a controller. The controller determines whether an amount of air flowing to the other heat exchanger needs to be increased and controls an opening degree of the shutter in a closing direction to reduce an amount of air flowing to a specified heat exchanger and increase an amount of air flowing to another heat exchanger upon determining that the amount of air flowing to the other heat exchanger needs to be increased.

### CROSS REFERENCE TO RELATED APPLICATION

The present application is a continuation application of International Patent Application No. PCT/JP2020/017363 filed on Apr. 22, 2020, which designated the U.S. and claims the benefit of priority from Japanese Patent Application No. 2019-091111 filed on May 14, 2019. The entire disclosures of all of the above applications are incorporated herein by reference.

### TECHNICAL FIELD

The present disclosure relates to a cooling system.

### BACKGROUND

A cooling system includes an airflow adjustment guide configured to adjust a ratio of an amount of traveling air flowing to a vehicular condenser and a radiator to an amount of traveling air flowing to an intercooler. The condenser and the radiator are arranged in a flow direction of the traveling air. The condenser is located at a position upstream of the radiator in the flow direction of the traveling air. The intercooler is adjacent to the condenser and the radiator in a direction perpendicular to the flow direction of the traveling air.

### SUMMARY

A cooling system according to one aspect of the present disclosure includes multiple heat exchangers, a shutter, and a controller. The multiple heat exchangers cool a fluid flowing therein by exchanging heat between the fluid and air flowing outside the heat exchangers. The multiple heat exchangers includes a specified heat exchanger and another heat exchanger that is different from the specified heat exchanger. The shutter faces a core surface of the specified heat exchanger of the multiple heat exchangers, and adjusts a flow amount of air flowing to the specified heat exchanger. The controller controls the shutter. The controller determines whether an amount of air flowing to the other heat exchanger needs to be increased. The controller controls an opening degree of the shutter in a closing direction to reduce the amount of air flowing to the specified heat exchanger and to increase the amount of air flowing to the other heat exchanger upon determining that the amount of air flowing to the other heat exchanger needs to be increased.

### BRIEF DESCRIPTION OF THE DRAWINGS

FIG. 1 is a diagram of a cooling system according to a first embodiment.

FIG. 2 is a schematic perspective view of the cooling system according to the first embodiment.

FIG. 3 is a block diagram of an electric configuration of the cooling system according to the first embodiment.

FIG. 4 is a flow chart of a process executed by a controller in the first embodiment.

FIG. 5 is a schematic view illustrating an operation example of the cooling system of the first embodiment.

FIG. 6 is a diagram of a cooling system of a first modification of the first embodiment.

FIG. 7 is a diagram of a cooling system of a second modification of the first embodiment.

FIG. 8 is a schematic perspective view of a cooling system according to a second embodiment.

FIG. 9 is a block diagram of an electric configuration of the cooling system according to the second embodiment.

FIG. 10 is a perspective view of a cooling system of a first modification of the second embodiment.

FIG. 11 is a perspective view of a cooling system of a second modification of the second embodiment.

FIG. 12 is a schematic perspective view of another example of a cooling system.

FIG. 13 is a schematic perspective view of another example of a cooling system.

### DESCRIPTION OF EMBODIMENTS

To begin with, examples of relevant techniques will be described.

A cooling system includes an airflow adjustment guide configured to adjust a ratio of an amount of traveling air flowing to a vehicular condenser and a radiator to an amount of traveling air flowing to an intercooler. The condenser and the radiator are arranged in a flow direction of the traveling air. The condenser is located at a position upstream of the radiator in the flow direction of the traveling air. The intercooler is adjacent to the condenser and the radiator in a direction perpendicular to the flow direction of the traveling air.

The airflow adjustment guide is a plate member that is located between the condenser and the intercooler and extends toward upstream in the flow direction of the traveling air. The airflow adjustment guide has a rotation axis between the condenser and the intercooler and rotates about the rotation axis to increase an amount of the traveling air flowing to the radiator and the condenser, or an amount of the traveling air flowing to the intercooler. The cooling system rotates the airflow adjustment guide to increase the amount of the traveling air flowing to the intercooler in a high-speed traveling period in which a traveling speed of the vehicle is faster than a predetermined speed. The cooling system rotates the airflow adjustment guide to increase the amount of the traveling air flowing to the radiator and the condenser when a temperature of engine cooling water increases or an air conditioning load is increased due to an increase in a pressure of the condenser.

The cooling system can improve an accuracy of controlling the flow amount of air as lengthening a length of the airflow adjustment guide while increasing in size. In contrast, the cooling system can be downsized by shortening the length of the airflow adjustment guide while reducing the accuracy of controlling the flow amount of air. The accuracy of controlling the flow amount of air and the size of the cooling system are in an opposite relationship, thus achievement of both of improving the accuracy of controlling and downsizing is difficult.

It is an object of the present disclosure to provide a cooling system that improves both an accuracy of controlling a flow amount of air and a mountability.

A cooling system according to one aspect of the present disclosure includes multiple heat exchangers, a shutter, and a controller. The multiple heat exchangers cool a fluid flowing therein by exchanging heat between the fluid and air flowing outside the heat exchangers. The multiple heat exchangers includes a specified heat exchanger and another heat exchanger that is different from the specified heat exchanger. The shutter faces a core surface of the specified heat exchanger of the multiple heat exchangers, and adjusts a flow amount of air flowing to the specified heat exchanger. The controller controls the shutter. The controller determines whether an amount of air flowing to the other heat exchanger needs to be increased. The controller controls an opening degree of the shutter in a closing direction to reduce the amount of air flowing to the specified heat exchanger and to increase the amount of air flowing to the other heat exchanger upon determining that the amount of air flowing to the other heat exchanger needs to be increased.

According to this configuration, the controller controls the shutter and adjusts the flow amount of air flowing through the other heat exchanger, so that the accuracy of controlling the flow amount of air. Additionally, the shutter is disposed to face the core surface of the specified heat exchanger, so that a member to adjust the flow amount of air does not greatly extend in an airflow direction. Thus, a mountability can be secured.

Hereinafter, embodiments will be described with reference to drawings. In the embodiments, the same elements in the drawings may be assigned with the same reference numeral as long as possible and redundant explanation may be omitted for description purposes.

### First Embodiment

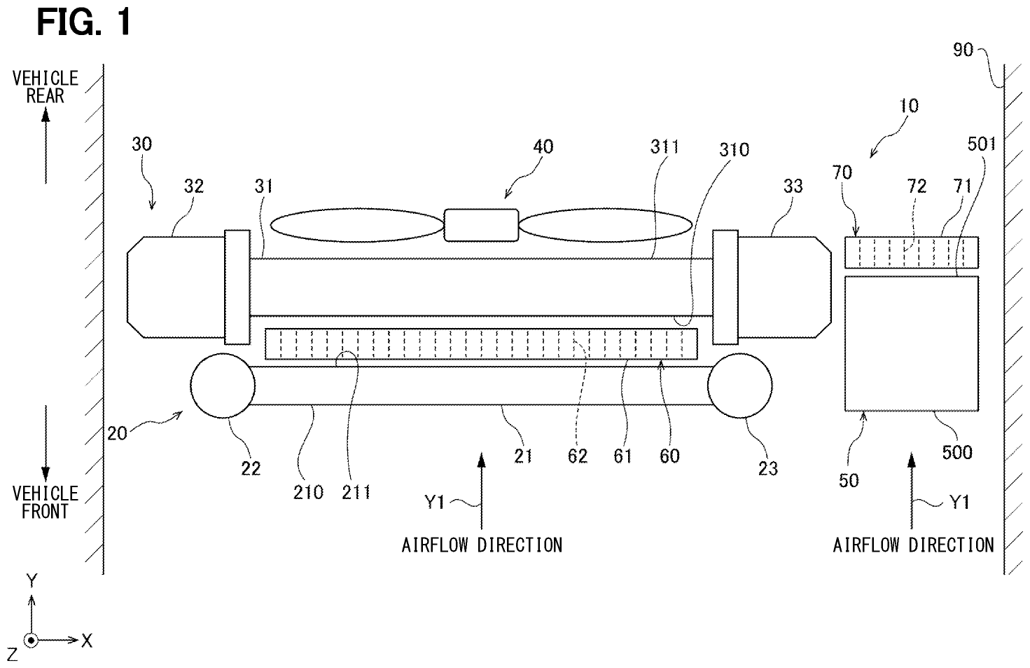

Firstly, a cooling system 10 according to a first embodiment shown in FIG. 1 will be described. The cooling system 10 is mounted in a vehicle. The cooling system 10 includes a condenser 20, a radiator 30, a blower 40, an intercooler 50, a first shutter 60, and a second shutter 70. These elements are disposed in an air passage 90 in an engine compartment of the vehicle. In the air passage 90, an air introduced from a grill opening of the vehicle (i.e., a travelling air) flows in a direction of an arrow Y1. In this embodiment, the condenser 20 and the radiator 30 correspond to a specified heat exchanger, and the intercooler 50 corresponds to another heat exchanger that is different from the specified heat exchanger.

In following, a direction of the arrow Y1 is referred to as an “airflow direction Y1”. The air introduced from the grill opening of the vehicle is referred to as an “outside air”. A direction of an arrow X shown in the drawings is a lateral direction of the vehicle, and a direction of an arrow Y is a front-rear direction of the vehicle. A direction of an arrow Z is a height direction of the vehicle.

The condenser 20 is one of elements that configure a refrigeration cycle in an air conditioner mounted in the vehicle. The condenser 20 is a heat exchanger in which a refrigerant circulating through the refrigerant cycle exchanges heat with the outside air to be cooled and condensed. The condenser 20 includes a core 21 and tanks 22 and 23.

The core 21 includes multiple tubes and multiple fins. The multiple tubes are stacked with a predetermined clearance therebetween in the height direction Z. The multiple tubes extend in the lateral direction X. Each of the tubes defines a passage therein through which the refrigerant flows. The outside air flows through the clearances between the adjacent tubes in the direction of the arrow Y1. The fins are located between the adjacent tubes. The fins increase a heat transfer area for the outside air to improve a heat exchange efficiency of the condenser 20. In following, an outer surface of the core 21 at a position upstream of the core 21 in the airflow direction Y1 is referred to as an “upstream core surface 210”, and an outer surface of the core 21 at a position downstream of the core 21 in the airflow direction Y1 is referred to as a “downstream core surface 211”.

The tanks 22 and 23 are respectively disposed at both ends of the core 21 in the lateral direction X. The tank 22 distributes the refrigerant into the tubes of the core 21, and the refrigerant flowing out of the tubes of the core 21 are merged in the tank 23.

In the condenser 20, the refrigerant flowing in the tubes of the core 21 exchanges heat with the outside air flowing around the tubes of the core 21 to be cooled and condensed.

The radiator 30 is disposed at a position downstream of the condenser 20 in the airflow direction Y1. The radiator 30 is a heat exchanger in which an engine cooling water exchanges heat with the outside are to be cooled. The radiator 30 includes a core 31 and tanks 32 and 33.

The core 31 is formed of multiple tubes and multiple fines, similarly to the core 21 of the condenser 20. In following, an outer surface of the core 31 at a position upstream of the core 31 in the airflow direction Y1 is referred to as an “upstream core surface 310”, and an outer surface of the core 31 at a position downstream of the core 31 in the airflow direction Y1 is referred to as a “downstream core surface 311”.

The tanks 32 and 33 are respectively disposed at both ends of the core 31 in the lateral direction X. The tank 32 distributes the engine cooling water into the tubes of the core 31, and the engine cooling water flowing out of the tubes of the core 31 is merged in the tank 33.

In the radiator 30, the engine cooling water flowing in the tubes of the core 31 exchanges heat with the outside air flowing around the tubes of the core 31 to be cooled.

The blower 40 is disposed at a position downstream of the radiator 30 in the airflow direction Y1. The blower 40 includes a fan rotatable when being energized. The blower 40 forcibly generates a flow of air in the airflow direction Y1 and supplies the outside air to the condenser 20 and the radiator 30 when the fan rotates.

The intercooler 50 is adjacent to the condenser 20 and the radiator 30 in the lateral direction X. The intercooler 50 is arranged in a direction perpendicular to the airflow direction Y1 relative to the condenser 20 and the radiator 30. Through the intercooler 50, an intake air drawn into an internal combustion engine of the vehicle flows. The intake air for the internal combustion engine flowing in the intercooler 50 exchanges heat with the outside air flowing around the intercooler 50 to be cooled. In following, an outer surface of the intercooler 50 at a position upstream of the intercooler 50 in the airflow direction Y1 is referred to as an “upstream core surface 500” and an outer surface of the intercooler 50 at a position downstream of the intercooler 50 in the airflow direction Y1 is referred to as a “downstream core surface 501”.

In this embodiment, the refrigerant flowing in the condenser 20, the engine cooling water flowing in the radiator 30, and the intake air for the internal combustion engine flowing in the intercooler 50 correspond to fluids flowing in heat exchangers.

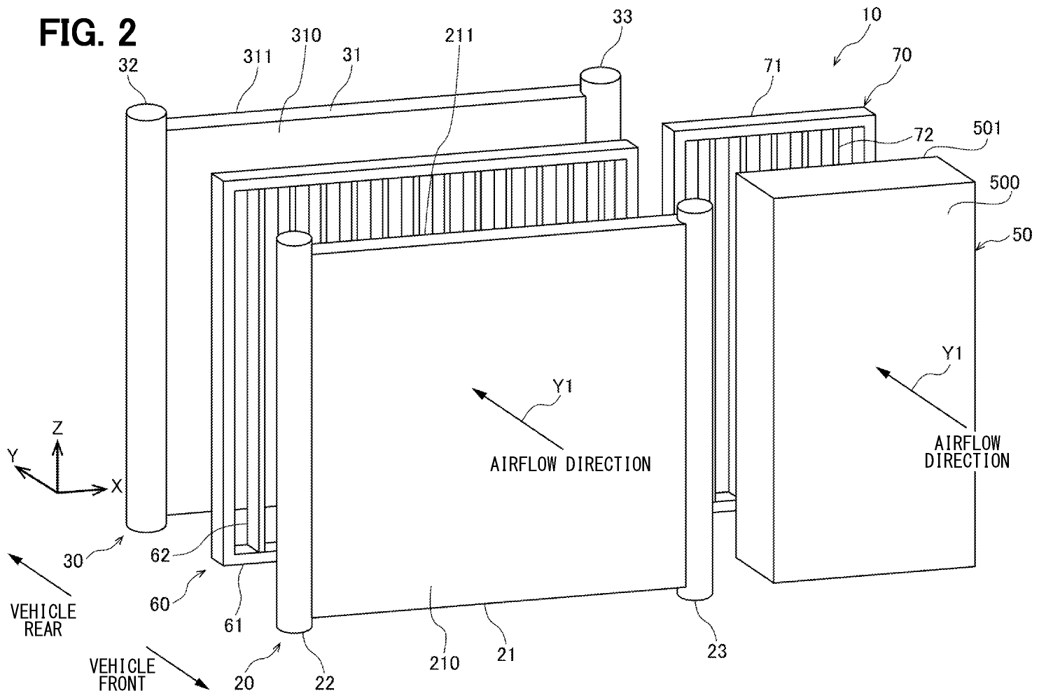

The first shutter 60 is located between the core 21 of the condenser 20 and the core 31 of the radiator 30. The first shutter 60 faces the downstream core surface 211 of the condenser 20 and the upstream core surface 310 of the radiator 30. As shown in FIG. 2, the first shutter 60 is a so-called blade shutter including a frame 61 having a rectangular shape and multiple blades 62 for opening and closing an inner space of the first shutter 60. The multiple blades 62 extend in the height direction Z. The multiple blades 62 are arranged with a predetermined clearance therebetween in the lateral direction X. Both ends of the blades 62 are supported to be rotatable by the frame 61.

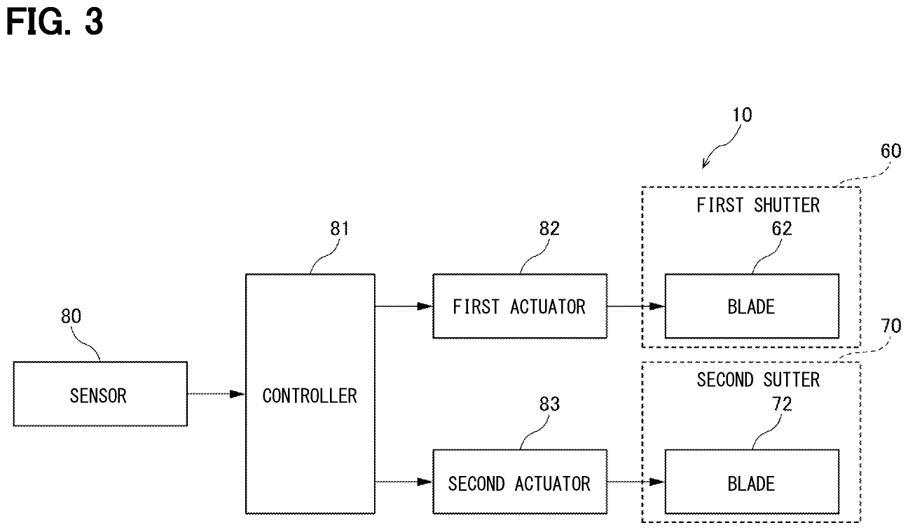

As shown in FIG. 3, the cooling system 10 includes a first actuator 82 to rotate the blades 62 of the first shutter 60. The first actuator 82 rotates the blades 62 to open or close the inner space of the frame 61. When the inner space of the frame 61 is open, i.e., the first shutter 60 is in an open state, the outside air can flow through the inner space of the frame 61, and the outside air is thereby supplied to the condenser 20 and the radiator 30. When the inner space of the frame 61 is closed by the rotation of the blades 62, the outside air cannot flow through the inner space of the frame 61, and the supply of the outside air with the condenser 20 and the radiator 30 is thereby restricted. The first shutter 60 can arbitrarily define an opening degree of the inner space of the frame 61 by controlling a rotation angle of the blades 62 so as to adjust a flow rate of the outside air supplied to the condenser 20 and the radiator 30.

As shown in FIG. 2, the second shutter 70 is located at a position downstream of the intercooler 50 in the airflow direction Y1. The second shutter 70 faces the downstream core surface 501 of the intercooler 50. The second shutter 70 includes a frame 71 having a rectangular shape and multiple blades 72 for opening and closing an inner space of the frame 71, similarly to the first shutter 60. The multiple blades 72 extend in the height direction Z. The blades 72 are arranged with a predetermined clearance therebetween in the lateral direction X. Both ends of the blades 72 are supported to be rotatable by the frame 71.

As shown in FIG. 3, the cooling system 10 includes a second actuator 83 to rotate the multiple blades 72 of the second shutter 70. The second actuator 83 rotates the multiple blades 72 to open or close the inner space of the frame 71. When the inner space of the frame 71 is open, i.e., the second shutter 70 is in an open state, the outside air can pass through the inner space of the frame 71, and the outside air is thereby supplied to the intercooler 50. When the inner space of the frame 71 is closed by the rotation of the blades 72, i.e., the second shutter 70 is in a closed state, the outside air cannot pass through the inner space of the frame 71, thereby preventing a supply of the outside air to the intercooler 50. The second shutter 70 can arbitrarily define an opening degree of the inner space of the frame 71 by controlling a rotation angle of the blades 72, and a flow rate of the outside air supplied to the intercooler 50 is thereby adjusted.

As shown in FIG. 3, the cooling system 10 further includes at least one in-vehicle sensor 80 and a controller 81.

The in-vehicle sensor 80 is a sensor mounted in the vehicle to detect a traveling state of the vehicle. The in-vehicle sensor 80 may be an accelerator position sensor that detects a degree of stepping down an accelerator pedal.

The controller 81 is formed mainly of a microcomputer including a CPU and a memory. In this embodiment, the controller 81 corresponds to a controller. The controller 81 controls operations of the first actuator 82 and the second actuator 83 to control the open and closed states of the first shutter 60 and the second shutter 70.

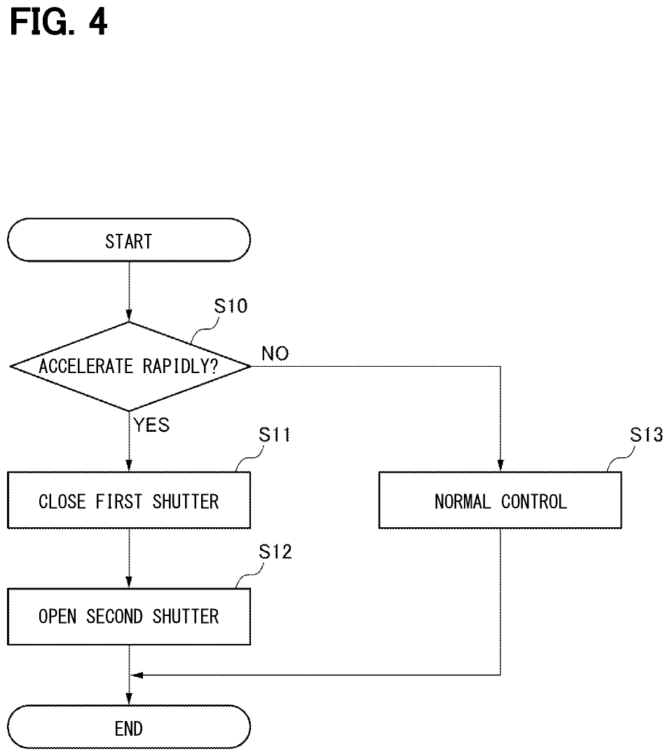

Next, an opening and closing control of the first shutter 60 and the second shutter 70 executed by the controller 81 will be concretely described with reference to FIG. 4. The controller 81 repeats a process described in FIG. 4 on a predetermined cycle.

As shown in FIG. 4, the controller 81 determines whether the vehicle is accelerated rapidly or not at step S10. The controller 81 may detect the degree of stepping down the accelerator pedal based on output signals of the accelerator position sensor that is included in the in-vehicle sensor 80. When the degree of stepping down the accelerator pedal is equal to or greater than a predetermined value, the controller 81 determines that the vehicle is accelerated rapidly. During the rapid acceleration of the vehicle, an output of the internal combustion engine needs to be increased, thus enhancing a cooling capacity of the intercooler 50 for the intake air is effective. In the cooling system 10 according to this embodiment, during the rapid acceleration of the vehicle, the amount of the outside air flowing around the intercooler 50 is increased to enhance the cooling capacity of the intercooler 50 for the intake air. In this embodiment, the determination process at step S10 can be used as a process that determines whether the amount of the outside air flowing through the intercooler 50 needs to be increased.

The controller 81 executes normal controls of the first shutter 60 and the second shutter 70 at step S13 upon determining that the vehicle is not accelerated rapidly at step S10. The normal controls of the first shutter 60 and the second shutter 70 are separately performed.

For example, the controller 81 closes the shutters 60 and 70 in the normal controls when the internal combustion engine is cold started. Accordingly, the outside air is temporary restricted to flow into the engine compartment, thereby allowing the internal combustion engine to be heated rapidly.

The controller 81 controls the opening degree of the first shutter 60 in the normal control according to an engine ECU that controls the internal combustion engine and an air conditioner ECU that controls the air conditioner. The engine ECU monitors a temperature of the engine cooling water with a water temperature sensor, and instructs the controller 81 to control the opening degree of the first shutter 60 based on the temperature of the engine cooling water detected by the water temperature sensor. For example, the engine ECU instructs the controller 81 to open the first shutter 60 for reducing the temperature of the engine cooling water when the temperature of the engine cooling water is equal to or greater than a predetermined temperature. The air conditioner ECU monitors a pressure of the refrigerant discharged from the condenser 20 with a pressure sensor, and instructs the controller 81 to control the opening degree of the first shutter 60 according to the pressure of the refrigerant detected by the pressure sensor. The air conditioner ECU determines that the refrigerant has a high temperature when the pressure of the refrigerant is equal to or greater than a predetermined value, and instructs the controller 81 to open the first shutter 60 for reducing the temperature of the refrigerant.

The controller 81 controls the opening degree of the second shutter 70 based on the instruction from the engine ECU in the normal control. The engine ECU instructs the controller 81 to control the opening degree of the second shutter 70 according to a vehicle speed detected by a vehicle speed sensor. The engine ECU instructs the controller 81 to open the second shutter 70 to cool the intake air of the internal combustion engine and enhance the output of the internal combustion engine when the vehicle speed is equal to or greater than a predetermined speed.

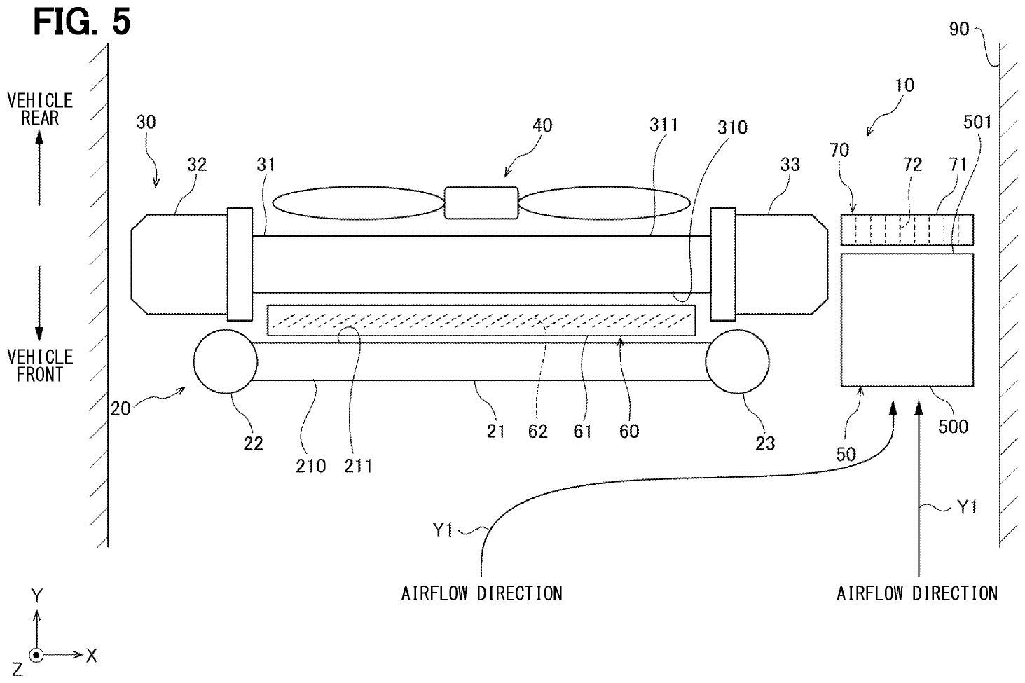

In contrast, when the controller 81 makes a positive determination at step S10, i.e., the vehicle is in the rapid acceleration state, the controller 81 determines that the amount of the outside air flowing to the intercooler 50 needs to be increased. In this case, the controller 81 closes the first shutter 60 at step S11 and opens the second shutter 70 at step S12. Accordingly, as shown in FIG. 5, a supply of the outside air to the condenser 20 and the radiator 30 is stopped, and most of the outside air flowing in the air passage 90 pass through the intercooler 50. The flow rate of the outside air flowing to the intercooler 50 is increased, thus the intake air flowing in the intercooler 50 is further cooled. As a result, the output of the internal combustion engine is enhanced, and the vehicle can thereby stand the rapid acceleration.

At step S11, the opening degree of the first shutter 60 may be set such that the blades 62 slightly opens the inner space of the frame 61 from a complete closed state of the blades 62. That is, at step S11, the opening degree of the first shutter 60 can be set at a value shifted from the opening degree in the normal control to a closing direction, and the opening degree of the first shutter 60 is determined appropriately. When the opening degree of the first shutter 60 is shifted from that in the normal control to the closing direction at step S11, the flow rate of the outside air flowing to the intercooler 50 is increased. Thus, the intake air flowing in the intercooler 50 is further cooled.

According to the cooling system 10 of the present embodiment described above, the following advantages (1) and (2) can be obtained.

(1) When the controller 81 determines that the amount of the outside air flowing to the intercooler 50 needs to be increased at step S10 in the process shown in FIG. 4, the controller 81 shifts the opening degree of the first shutter 60 to the closing direction to reduce the amount of the outside air flowing to the condenser 20 and the radiator 30, and to increase the amount of the outside air flowing to the intercooler 50. According to such configuration, even when a required amount of the outside air flowing to the intercooler 50 is increased, the controller 81 controls the first shutter 60 and the second shutter 70 to increase the amount of the outside air flowing to the intercooler 50. Thus, the accuracy of controlling the amount of air is secured. The first shutter 60 faces the downstream core surface 211 of the condenser 20 and the upstream core surface 310 of the radiator 30. The second shutter 70 faces the downstream core surface 501 of the intercooler 50. Accordingly, a member to adjust the amount of air does not extend in the airflow direction Y1, thereby the mountability can be secured.

(2) The first shutter 60 is located at a position downstream of the condenser 20 in the airflow direction Y1. According to such configuration, a structure is unnecessary to be provided at a position upstream of the condenser 20 in the airflow direction Y1, which improves the mountability.

### First Modification

Next, a first modification of the cooling system 10 in the first embodiment will be described.

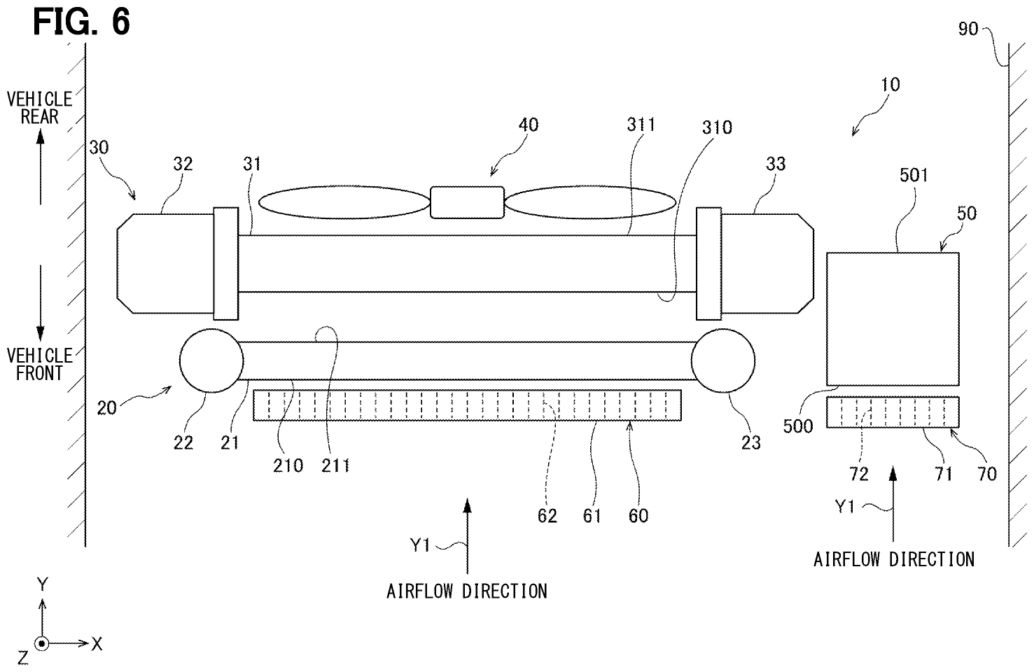

As shown in FIG. 6, the first shutter 60 is located at a position upstream of the condenser 20 in the airflow direction Y1 in the cooling system 10 of the present modification. The second shutter 70 is located at a position upstream of the intercooler 50 in the airflow direction Y1.

Also with this configuration, the advantage (1) described above can be obtained. When the first shutter 60 and the second shutter 70 are closed, a flow of the outside air is shut at a position upstream of that in the first embodiment. Thus, the outside air can be restricted to enter into the engine compartment more accurately. As a result, an aerodynamic performance of the vehicle is likely to be improved.

### Second Modification

Next, a second modification of the cooling system 10 in the first embodiment will be described.

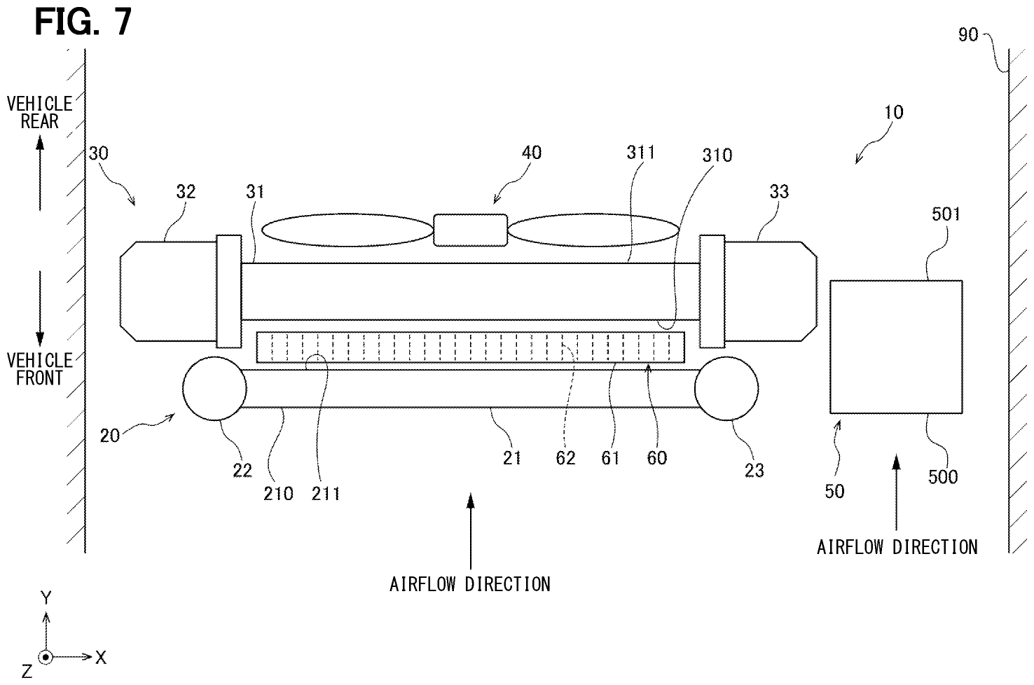

As shown in FIG. 7, a cooling system 10 in this modification is different from the cooling system in the first embodiment in that the cooling system 10 in the modification does not include the second shutter 70. That is, in the cooling system 10 of this modification, only the first shutter 60 is disposed to face the downstream core surface 211 of the condenser 20 and the upstream core surface 310 of the radiator 30. The controller 81 executes a process shown in FIG. 4 except for step S12. Even in this configuration, the advantage (1) described above can be obtained. The second shutter 70 corresponding to the intercooler 50 is not provided, thus the configuration of the cooling system 10 can be simpler.

### Second Embodiment

A cooling system 10 according to a second embodiment will be described mainly at different points from the cooling system 10 in the first embodiment.

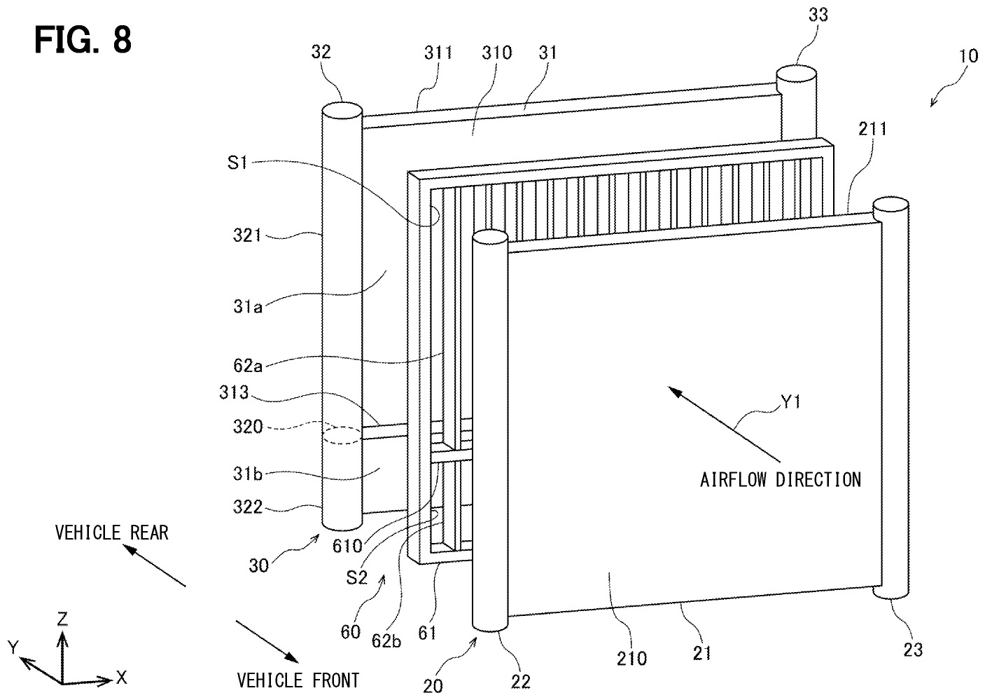

As shown in FIG. 8, the cooling system 10 in this embodiment differs from the cooling system 10 in the first embodiment at a point that the cooling system 10 in the second embodiment does not include the intercooler 50 and the second shutter 70. The core 31 of the radiator 30 in this embodiment is divided into a first core 31a and a second core 31b. The first core 31a and the second core 31b are arranged in a direction perpendicular to the airflow direction Y1. A high-temperature cooling water flows in tubes of the first core 31a. The high-temperature cooling water may be a cooling water for cooling the internal combustion engine. In the first core 31a, the high-temperature cooling water exchanges heat with the outside air flowing outside the tubes of the first core 31a to be cooled. A low-temperature cooling water flows in tubes of the second core 31b. The low-temperature cooling water may be a cooling water for cooling an electric motor for vehicle traveling and peripheral devices. An area of the second core 31b is smaller than that of the first core 31a. In the second core 31b, the low-temperature cooling water exchanges heat with the outside air flowing outside the tubes of the second core 31b to be cooled. In following, a boundary between the first core 31a and the second core 31b of the core 31 is referred to as a “core boundary 313”.

The tank 32 includes a partition 320 that divides an inner space of the tank 32 into a first tank space 321 and a second tank space 322. The tank 33 also includes a partition that divides an inner space of the tank 33 into a first tank space and a second tank space. The first tank space 321 of the tank 32 and the first tank space of the tank 33 are fluidly connected to the tubes of the first core 31a. The first tank space 321 distributes the high-temperature cooling water into the tubes of the first core 31a and the high-temperature cooling water flowing out of the tubes of the first core 31a are merged in the first tank space of the tank 33. The second tank space 322 of the tank 32 and the second tank space of the tank 33 are fluidly connected to the tubes of the second core 31b. The second tank space 322 distributes the low-temperature cooling water into the tubes of the second core 31b, and the low-temperature cooling water flowing through the tubes of the second core 31b are merged in the second tank space of the tank 33.

The frame 61 of the shutter 60 includes a bridge 610 that divides the inner space of the frame 61 into a first inner space S1 and a second inner space S2. The bridge 610 is located corresponding to the core boundary 313 of the radiator 30 in the airflow direction Y1. The first inner space S1 of the frame 61 faces the first core 31a of the radiator 30. The second inner space S2 of the frame 61 faces the second core 31b of the radiator 30.

The shutter 60 includes first blades 62a arranged in line in the first inner space S1 of the frame 61 and second blades 62b arranged in line in the second inner space S2 of the frame 61.

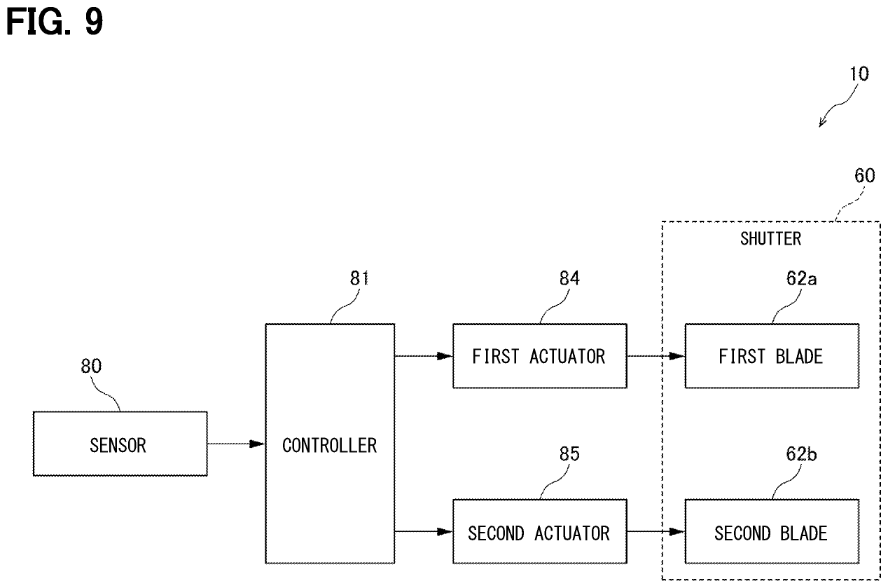

As shown in FIG. 9, the cooling system 10 includes a first actuator 84 that rotates the first blades 62a, and a second actuator 85 that rotates the second blades 62b. The first actuator 84 rotates the first blades 62a to open or close the first inner space S1 of the frame 61. The second actuator 85 rotates the second blades 62b to open or close the second inner space S2 of the frame 61.

Next, operation of the cooling system 10 in this embodiment will be described.

The controller 81 in this embodiment controls the actuators 84 and 85 to open the first blades 62a and close the second blades 62b upon determining that the cooling capacity for the high-temperature cooling water needs to be increased based on operation conditions detected by the in-vehicle sensor 80. The opening degree of the second blades 62b is not limited to a complete closed state, but may be a slightly opened from the complete closed state. Accordingly, almost all of the outside air flowing in the air passage 90 shown in FIG. 1 flows through the first core 31a of the radiator 30. The flow rate of the outside air flowing in the first core 31a is increased, thereby increasing the cooling capacity of the high-temperature cooling water flowing in the first core 31a. In this case, the second core 31b corresponds to the specified heat exchanger, and the first core 31a corresponds to another heat exchanger that is different from the specified heat exchanger.

The controller 81 controls the actuators 84 and 85 to rotate the first blades 62a to a closing direction and the second blades 62b to an opening direction when the cooling capacity for the low-temperature cooling water is increased based on operation states detected by the in-vehicle sensor 80. The opening degree of the first blades 62a is not limited to a complete closed state, but may be a slightly shifted from the complete closed state to the opening direction. Accordingly, almost all of the outside air flowing in the air passage 90 shown in FIG. 1 passes through the second core 31b of the radiator 30. The amount of the outside air flowing in the second core 31b is increased, thereby increasing the cooling capacity for the low-temperature cooling water flowing in the second core 31b. In this case, the first core 31a corresponds to the specified heat exchanger, and the second core 31b corresponds to the other heat exchanger that is different from the specified heat exchanger.

According to the cooling system 10 described above, the following advantages (3) and (4) can be obtained.

(3) Even when an amount of air required in the cores 31a and 31b is increased, the controller 81 controls the shutter 60 to adjust the amount of the outside air flowing through the cores 31a and 31b. Thus, the accuracy of adjusting the amount of air is secured. The shutter 60 faces the downstream core surface 211 of the condenser 20 and the upstream core surface 310 of the radiator 30. Accordingly, a member to adjust the amount of air does not extend in the airflow direction Y1, and the mountability can be secured.

(4) The first core 31a and the second core 31b are integrally provided as the radiator 30 that is a single heat exchanger. According to this configuration, compared to a structure having a heat exchanger for the high-temperature cooling water and another heat exchanger for the low-temperature cooling water, the structure can be simple.

### First Modification

Next, a first modification of the cooling system 10 in the second embodiment will be described.

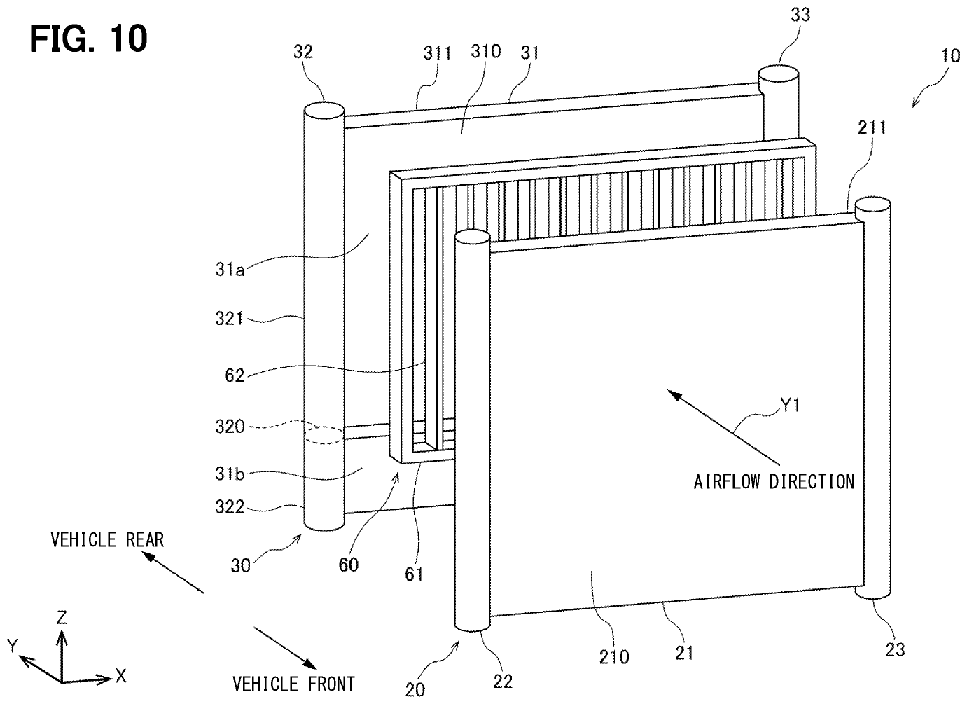

As shown in FIG. 10, a cooling system 10 in this modification includes the shutter 60 corresponding only to the first core 31a of the radiator 30 but a shutter corresponding to the second core 31b is omitted. According to this configuration, when the amount of air required in the second core 31b is increased, the controller 81 controls the shutter 60 to be closed to increase the amount of the outside air flowing in the second core 31b. Thus, an accuracy of controlling the amount of air can be secured.

### Second Modification

Next, a second modification of the cooling system 10 in the second embodiment will be described.

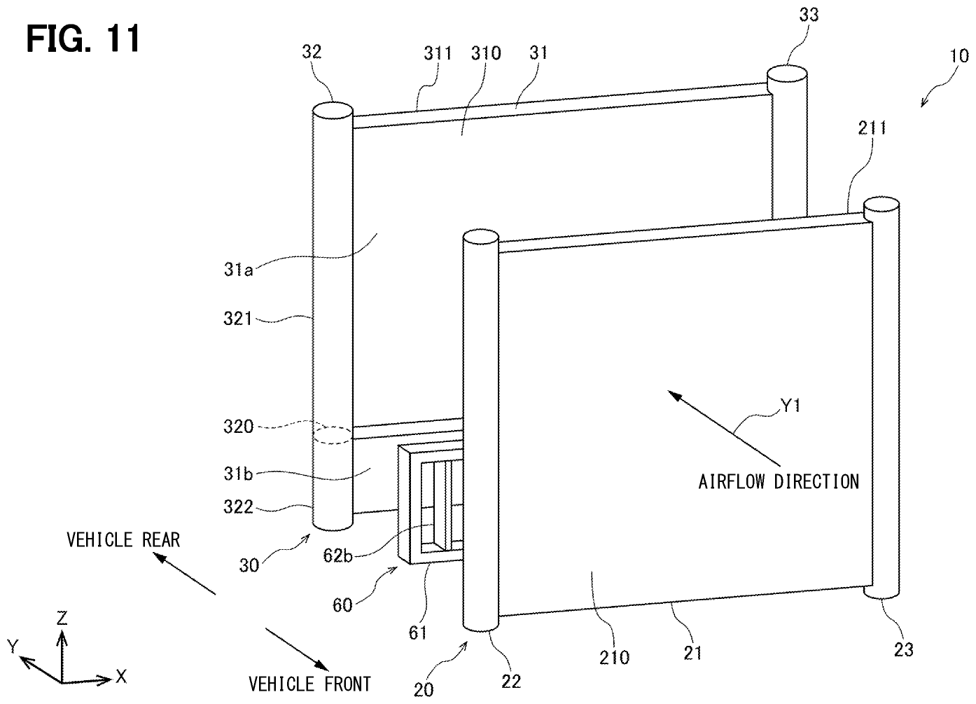

As shown in FIG. 11, the cooling system 10 in this modification includes the shutter 60 corresponding only to the second core 31b of the radiator 30. According to this configuration, when the amount of the air required in the first core 31a is increased, the controller 81 controls the shutter 60 to be closed to increase the amount of the outside air flowing in the first core 31a. Thus, an accuracy of controlling the amount of air can be secured.

### Other Embodiment

The above-mentioned embodiment may be suitably modified without limiting the above structures.

The controller 81 in the first embodiment may change the opening degree of the second shutter 70 to the closing direction from the opening degree in the normal control, when the controller 81 determines that the amount of the outside air flowing through the condenser 20 and the radiator 30 needs to be increased. Accordingly, the amount of the outside air flowing through the intercooler 50 is decreased, and the amount of the outside air flowing through the condenser 20 and the radiator 30 is increased.

The control operation of the shutters 60 and 70 executed by the controller 81 in the first embodiment may be changed appropriately. For example, when the vehicle travels in a middle speed or a high speed, the controller 81 may set the opening degree of the first shutter 60 as a degree slightly opened from the complete closed state, and close the second shutter 70. According to this configuration, the amount of air introduced into the engine compartment is reduced, and the aerodynamic performance of the vehicle can be improved. The controller 81 can supply an appropriate amount of the air to appropriate one of the condenser 20, radiator 30, and the intercooler 50 by opening and closing the shutters 60 and 70 in response to various conditions of the vehicle. The similar configuration can be applied to the controller 81 in the second embodiment.

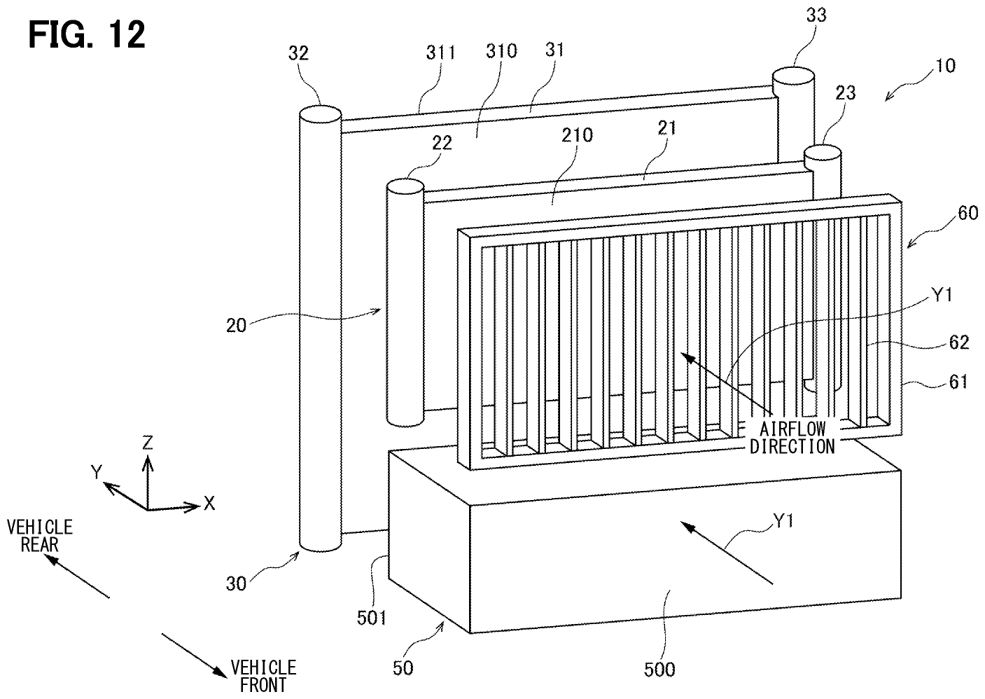

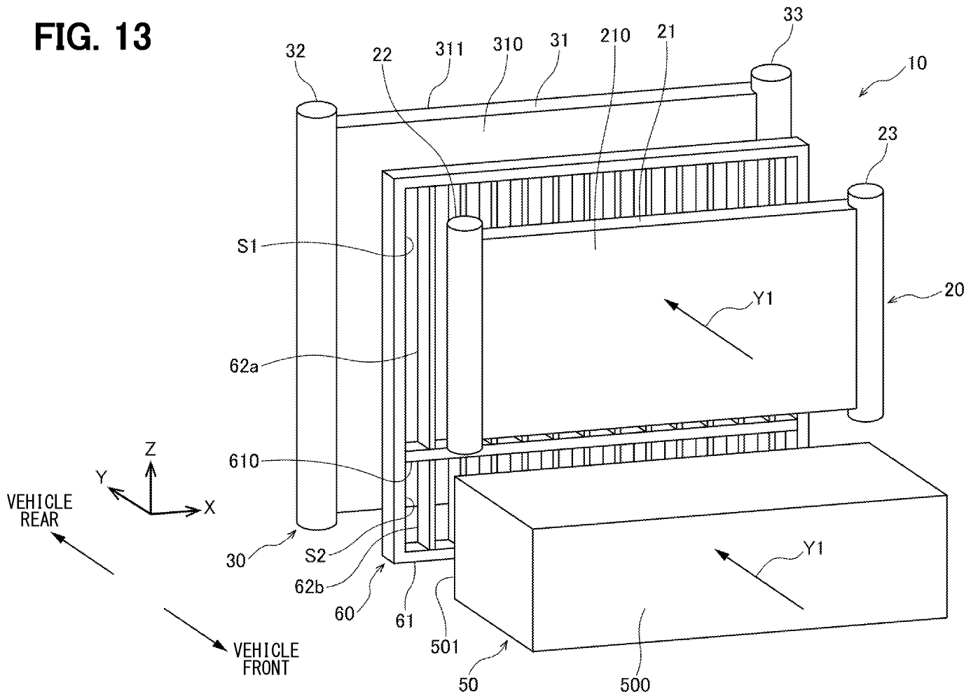

According to the configuration of the cooling system 10, shapes and arrangements of the shutters 60 and 70 can be altered appropriately. For example, in the cooling system 10 shown in FIG. 12, the condenser 20 and the intercooler 50 are arranged in line in the height direction Z, and the radiator 30 is arranged at a position downstream of the condenser 20 and the intercooler 50 to face the condenser 20 and the intercooler 50. In the cooling system 10 having such configuration, the shutter 60 may be located in front of the condenser 20 in the front-rear direction of the vehicle. In addition, as shown in FIG. 13, the shutter 60 may be located between the condenser 20/intercooler 50 and the radiator 30. The shutter 60 has the similar structure to the shutter 60 shown in FIG. 8 in which the inner space is divided into the first inner space S1 and the second inner space S2. The first inner space S1 faces the condenser 20. The second inner space S2 faces the intercooler 50. The shutter 60 includes the first blades 62a for opening and closing the inner space S1 and the second blades 62b for opening and closing the second inner space S2.

The controller 81 is not limited to perform a control operation in which the opening and closing of the shutters 60 and 70 is controlled based on the determination whether the vehicle is accelerated rapidly or not. The controller 81 may control the opening and closing of the shutters 60 and 70 based on an appropriate vehicle state. For example, the controller 81 detects the vehicle speed, the temperature of the engine cooling water, and the degree of stepping down the accelerator pedal based on the at least one in-vehicle sensor 80. The controller 81 may execute step S11 and step S12 shown in FIG. 4 upon detecting that the vehicle speed is equal to or lower than a predetermined speed, the temperature of the engine cooling water is equal to or lower than a predetermined temperature, and the degree of stepping down the accelerator pedal is equal to or greater than a predetermined threshold. The controller 81 may perform the normal control of step S13 in other conditions from the above-mentioned condition. The threshold to the degree of stepping down the accelerator pedal is determined such that the controller 81 can determine whether a kick-down is performed or not. Alternatively, the controller 81 may determine that the vehicle is deaccelerated to enter a curved road when the vehicle speed is equal to or lower than a predetermined speed, and perform the step S11 and step S12 shown in FIG. 4 at a same timing when the vehicle starts to be deaccelerated. In other conditions from the above-mentioned condition, the controller 81 may perform the normal control of step S13. The controller 81 may stop performing the process of step S11 and S12 for a certain time after the process of step S11 and S12 is once performed and then the normal control of step S13 may be performed. This avoids malfunctions caused by continuing execution of the process in steps S11 and S12.

Switching between the execution of the process of steps S11 and S12, and the execution of the normal control of step S13 may be performed based on a manual operation of a switch mounted in the vehicle by a passenger. When the switch is arranged in a range reachable from a hand of the passenger on seat, the switch may be operated by the hand of the passenger. If the switch is arranged in a range reachable from a leg of the passenger on seat, the switch may be operated by the leg of the passenger. A configuration to drive the shutters 60 and 70 based on the operation of the switch may be a configuration that transmits signals to the actuators 82 and 83 from the switch to drive the shutters 60 and 70 when the switch is operated or a configuration in which the switch and the shutters 60 and 70 are physically connected with a wire, and the shutters 60 and 70 are driven with linked to the operation of the switch.

The controller 81 and the control method described in this disclosure may be achieved by one or multiple exclusive computers provided with a memory and a processor programmed to execute one or multiple functions embodied by a computer program. The controller 81 and the control method thereof may be achieved by an exclusive computer provided with a processor including one or multiple exclusive hardware logic circuits. The controller 81 and the control method thereof may be achieved by an exclusive computer provided with a combination of a processor programmed to execute one or multiple functions and a processor including a memory and one or multiple exclusive hardware logic circuits. The computer program may be memorized in a non-transitory storage medium as an instruction performed by the computer. The exclusive hardware logic circuits and a hardware logic circuit may be achieved by a digital circuit including multiple logic circuits, or an analog circuit.

This disclosure is not limited to concrete embodiments described above. Alternations of the concrete embodiments by person in the art is included in a range of this disclosure as long as including technical features of this disclosure. Elements, arrangement, conditions, and shapes of the concrete embodiments are not limited in illustrations of this disclosure, and can be modified appropriately. Combination of the elements in the embodiments can be altered as long as technical contradictions does not occur.

What is claimed is:

1. A cooling system comprising:
a plurality of heat exchangers configured to exchange heat between a fluid flowing in each of the plurality of heat exchangers and an air flowing outside the plurality of heat exchangers to cool the fluid, the plurality of heat exchangers includes a specified heat exchanger and another heat exchanger that is different from the specified heat exchanger;
a shutter located to face a core surface of the specified heat exchanger and configured to adjust an amount of air flowing to the specified heat exchanger; and
a controller configured to control the shutter, wherein
the controller is further configured to:
determine whether an amount of air flowing to the other heat exchanger needs to be increased; and
control an opening degree of the shutter in a closing direction to reduce the amount of air flowing to the specified heat exchanger and increase the amount of air flowing to the other heat exchanger upon determining that the amount of air flowing to the other heat exchanger needs to be increased.

2. The cooling system according to claim 1, wherein
the shutter faces only the core surface of the specified heat exchanger of the plurality of the heat exchangers.

3. The cooling system according to claim 1, wherein
the shutter is located at a position upstream of the specified heat exchanger in an airflow direction.

4. The cooling system according to claim 1, wherein
the shutter is located at a position downstream of the specified heat exchanger in an airflow direction.

5. The cooling system according to claim 1, wherein
the shutter is a blade type shutter including a plurality of blades and configured to adjust the amount of air flowing to the specified heat exchanger by opening or closing the plurality of blades.

6. The cooling system according to claim 1, wherein
the specified heat exchanger and the other heat exchanger are arranged in a direction perpendicular to an airflow direction.

7. The cooling system according to claim 1, wherein
the specified heat exchanger includes a radiator configured to cool an engine cooling water for a vehicle and a condenser configured to cool a refrigerant circulating through a refrigerant cycle of an air conditioner in the vehicle, and
the other heat exchanger is an intercooler configured to cool air drawn into an internal combustion engine of the vehicle.

8. The cooling system according to claim 1, wherein
the specified heat exchanger and the other heat exchanger are provided as a single heat exchanger.

9. The cooling system according to claim 6, further comprising
a second shutter located to face a core surface of the other heat exchanger, and configured to adjust an amount of air flowing to the other heat exchanger, wherein
the shutter located to face the core surface of the specified heat exchanger is a first shutter, and
the controller is configured to control the opening degree of the first shutter in the closing direction and an opening degree of the second shutter in an opening direction to increase the amount of air flowing to the other heat exchanger upon determining that the amount of air flowing to the other heat exchanger needs to be increased.

10. A cooling system comprising:
a first heat exchanger configured to cool a first fluid through heat exchange between the first fluid and an air;
a second heat exchanger configured to cool a second fluid through heat exchange between the second fluid and the air;
a shutter located to face a core surface of the first heat exchanger and configured to adjust an amount of air flowing to the first heat exchanger; and
one or more processors coupled to an in-vehicle sensor and coupled to a memory storing program instruction that when executed by the one or more processors cause the one or more processors to at least:
determine whether an amount of air flowing to the second heat exchanger needs to be increased based on a vehicle state detected by the in-vehicle sensor; and
control an opening degree of the shutter to reduce the amount of air flowing to the first heat exchanger and to increase the amount of air flowing to the second heat exchanger upon determining that the amount of air flowing to the second heat exchanger needs to be increased.
